(19) United States
(12) Patent Application Publication
(10) Pub. No.: US 2003/0190434 A1
(43) Pub. Date: Oct. 9, 2003

(54) Process for applying automotive quality effect coatings to metal substrates

(76) Inventors: Alicia D. Byers, Pittsburgh, PA (US); John W. Burgman, Gibsonia, PA (US); Lana L. DeRouin, Pittsburgh, PA (US); Erik J. Humbert, Tarentum, PA (US); Hans F. Letzring, Pleasant Ridge, MI (US); Edward R. Millero JR., Gibsonia, PA (US)

Correspondence Address: PPG INDUSTRIES, INC., Intellectual Property Department, One PPG Place, Pittsburgh, PA, 15272, US

(21) Appl. No.: 10/407,611

(22) Filed: Apr. 4, 2003

Related U.S. Application Data
(60) Provisional application No. 60/370,155, filed on Apr. 5, 2002.

(51) Int. Cl. B05D 3/02; B05D 1/36; B05D 1/28

(52) U.S. Cl. 427/428; 427/421; 427/402; 427/385.5

(57) ABSTRACT

An improved process for applying a multi-component composite coating composition to a substrate is provided. The process includes the steps of roll applying to the substrate a colored film-forming composition to form a base coat and applying to said base coat at least one clear film-forming composition to form at least one transparent top coat over the base coat. At least one of the clear film-forming compositions contains an effect pigment.

Additionally, an improved process for applying a multi-component composite coating composition to a metal substrate is provided. The process may include the following steps:

a) optionally contacting the substrate surface with a pretreatment composition;

b) optionally applying a primer coating composition to the substrate surface;

c) curing the primer coating composition if applied;

d) roll applying to the substrate a colored film-forming composition to form a base coat;

e) curing the base coat;

f) applying to at least a portion of said base coat at least one clear film-forming composition to form at least one transparent top coat over the base coat; and

g) curing the at least one clear coat.

At least one of the clear film-forming compositions contains an effect pigment.

Substrates treated by the process of the present invention are suitable for use in the manufacturing of automotive parts, having automotive quality appearance.

### CROSS REFERENCE TO RELATED APPLICATIONS

This application claims the benefit of priority of Provisional U.S. Patent Application Serial No. 60/370,155, filed Apr. 5, 2002.

### BACKGROUND OF THE INVENTION

The present invention relates to a process for applying a multi-component composite coating composition to a substrate.

In the automotive industry as well as other general industrial manufacturing, there are ever-increasing demands for greater productivity, cost savings, and flexible and efficient production. Coupled with this are increasingly stringent requirements regarding environmental protection with respect to manufacturing operations and waste products. Such demands have to be met by modifying both raw materials and processing methods while still satisfying quality requirements expected by consumers.

In the automotive industry, modular manufacturing systems are being considered in vehicle assembly plants, because of the time and cost savings that can be realized by integrating pre-fabricated and pre-coated body parts on an assembly line. For example, coil coating of sheet metal prior to fabrication into automotive body parts is being considered as a cost-saving manufacturing process. However, in today's market for automobiles with “glamour” coatings, including metallic colors and decorative visual effect pigments, achieving acceptable appearance properties by roll applying coatings to substrates such as on a continuous coil line can be difficult.

It is well known to employ base coating compositions that contain metallic or reflective pigments in color-plus-clear coating systems. These are the so-called “glamour finishes” whereby a differential light reflection effect or color effect is achieved. These visual effects can be attributed to the orientation of the metallic and/or other reflective flake pigments in the base coat.

Appearance properties such as gloss, distinctness of image, and smoothness, for the most part, can be attributed to the unpigmented topcoat (i.e., the clear coat).

The base coating composition, which contains metallic and/or other reflective pigments, is conventionally formulated to maximize the color and other visual effects; and the top coating composition, which is substantially pigment-free, typically is formulated to maximize appearance properties such as the aforementioned gloss, distinctness of image (DOI), and smoothness properties. However, in a coil coating process, flake pigments present in a colored base coat can be compressed well below the coating surface due to the rolled application of the coating, and consequently may not exhibit the desired visual effect, even after application of a clear coat layer that would maximize gloss. Color matching with parts that are conventionally sprayed is also difficult to achieve.

It would be desirable to provide a process for coating substrates, particularly metal substrates, that is efficient, easily applicable to the automotive industry, and that yields coated substrates having outstanding visual effect and appearance properties currently in demand in the automotive market. It would also be desirable to provide a process for coating substrates providing an appropriate orientation of pigment flakes to achieve visual effect and appearance properties similar to conventionally spray applied metallic coatings.

### SUMMARY OF THE INVENTION

In accordance with the present invention, an improved process for applying a multi-component composite coating composition to a substrate is provided. The process comprises the steps of roll applying to the substrate a colored film-forming composition to form a base coat and applying to at least a portion of the base coat at least one clear film-forming composition to form at least one transparent top coat over the base coat. At least one of the clear film-forming compositions contains an effect pigment.

In an alternative embodiment of the invention, a process for applying a multi-component composite coating composition to a metal substrate is provided and comprises the following steps:

a) optionally contacting the substrate surface with a pretreatment composition; followed by

b) optionally applying a primer coating composition to the substrate surface;

c) curing the primer coating composition if applied;

d) roll applying to the substrate a colored film-forming composition to form a base coat;

e) curing the base coat;

f) applying to at least a portion of said base coat at least one clear film-forming composition to form at least one transparent top coat over the base coat; and

g) curing the at least one clear coat.

Again, at least one of the clear film-forming compositions contains an effect pigment.

Further provided are substrates coated by the process of the present invention.

### BRIEF DESCRIPTION OF THE DRAWING

FIG. 1 is a flow diagram depicting several embodiments of the process of the present invention.

FIG. 2 is a plot of spectrophotometric measurements of L* values versus viewing angle for five color-plus-clear composite coatings applied by various application techniques.

FIG. 3 is a plot of spectrophotometric measurements of “a values” versus viewing angle for the same five color-plus-clear composite coatings applied by various application techniques.

FIG. 4 is a plot of spectrophotometric measurements of “b values” versus viewing angle for five color-plus-clear composite coatings applied by various application techniques.

### DETAILED DESCRIPTION

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Substrates to be coated by the process of the present invention typically include metal substrates, preferably corrosion-resistant, electrically conductive substrates such as aluminum, stainless steel, and steel surface-treated with any of zinc metal, zinc compounds and zinc alloys (including electrogalvanized steel, hot-dipped galvanized steel, GALVANNEAL steel, and steel plated with zinc alloy). Also, copper, magnesium, and alloys thereof, aluminum alloys, zinc-aluminum alloys such as GALFAN, GALVALUME, aluminum plated steel and aluminum alloy plated steel substrates may be used. Steel substrates (such as cold rolled steel or any of the steel substrates listed above) coated with a weldable, zinc-rich or iron phosphide-rich organic coating are also suitable for use in the process of the present invention. Such weldable coating compositions are disclosed in U.S. Pat. Nos. 4,157,924 and 4,186,036. The term “corrosion-resistant” and the like refer to the relative resistance of the substrate to corrosion as compared to cold rolled steel. Plastic or elastomeric substrates may also be used.

The process of the present invention may be performed as a continuous process, and is most often performed as a coil coating process. Coil coating processes and the application methods used therein are described in detail in the article “Coil Coatings”, published as part of the Federation Series on Coatings Technology by the Federation of Societies for Coatings Technology, February, 1987.

The substrate to be coated is usually first cleaned to remove grease, dirt, or other extraneous matter. This is done by employing conventional cleaning procedures and materials. For example, these would include mild or strong alkaline cleaners such as are commercially available and conventionally used in metal pretreatment processes. Examples of alkaline cleaners include Chemkleen 163 and Chemkleen 177, both of which are available from PPG Industries, Pretreatment and Specialty Products. Such cleaners are generally followed and/or preceded by a water rinse.

Following the optional cleaning step, if the substrate is a metal, the metal surface may optionally be contacted with a pretreatment composition.

A metal surface may be rinsed with an aqueous acidic solution after cleaning with the alkaline cleaner and before pretreatment. Examples of rinse solutions include mild or strong acidic cleaners such as the dilute nitric acid or chromic acid solutions commercially available and conventionally used in metal pretreatment processes.

When using a corrosion resistant substrate in the process of the present invention a pretreatment step may not be necessary, but a metal substrate may be, for example, pretreated with a solution selected from the group consisting of a metal phosphate solution, an aqueous solution containing at least one Group IIIB or IVB metal, an organophosphate solution, an organophosphonate solution, and combinations thereof. The pretreatment solutions are preferably free of heavy metals such as chromium and nickel. Suitable phosphate conversion coating compositions may be any of those known in the art, with the proviso that they are free of heavy metals. Examples include zinc phosphate, iron phosphate, manganese phosphate, calcium phosphate, magnesium phosphate, cobalt phosphate, zinc-iron phosphate, zinc-manganese phosphate, zinc-calcium phosphate, and layers of other types, which may contain one or more multivalent cations. Phosphating compositions are known to those skilled in the art and are described in U.S. Pat. Nos. 4,941,930, 5,238,506, and 5,653,790.

The IIIB or IVB transition metals and rare earth metals referred to herein are those elements included in such groups in the CAS Periodic Table of the Elements as is shown, for example, in the Handbook of Chemistry and Physics, 63rd Edition (1983).

Typical group IIIB and IVB transition metal compounds and rare earth metal compounds are compounds of zirconium, titanium, hafnium, yttrium and cerium and mixtures thereof. Typical zirconium compounds may be selected from hexafluorozirconic acid, alkali metal and ammonium salts thereof, ammonium zirconium carbonate, zirconyl nitrate, zirconium carboxylates and zirconium hydroxy carboxylates such as hydrofluorozirconic acid, zirconium acetate, zirconium oxalate, ammonium zirconium glycolate, ammonium zirconium lactate, ammonium zirconium citrate, and mixtures thereof. Hexafluorozirconic acid is often employed. An example of a titanium compound is fluorotitanic acid and its salts. An example of a hafnium compound is hafnium nitrate. An example of a yttrium compound is yttrium nitrate. An example of a cerium compound is cerous nitrate.

Compositions to be used in the optional pretreatment step include non-conductive organophosphate and organophosphonate pretreatment compositions such as those disclosed in U.S. Pat. Nos. 5,294,265 and 5,306,526. Such organophosphate or organophosphonate pretreatments are available commercially from PPG Industries, Inc. under the name NUPAL®.

The pretreatment composition may be applied to the metal substrate by known application techniques, such as dipping or immersion, roll coating, spraying, intermittent spraying, dipping followed by spraying or spraying followed by dipping. Typically, the pretreatment composition is applied to the metal substrate at solution or dispersion temperatures ranging from ambient to 150° F. (ambient to 65° C.), and usually at ambient temperatures. The contact time is generally between 10 seconds and five minutes, typically 30 seconds to 2 minutes when dipping the metal substrate in the pretreatment composition or when the pretreatment composition is sprayed onto the metal substrate.

Following pretreatment, the substrate may optionally be coated with a primer coating composition. Examples of suitable primer coating compositions include any of those known in the art as suitable for use in a coil coating process.

If a primer coating composition is applied to the substrate it is then cured, depending on the chemistry of the coating composition, either by heating the substrate to a temperature and for a time sufficient to effect cure, lo or the substrate is exposed to a suitable radiation source if the coating composition is radiation curable. The term “radiation curable” as used herein refers to a class of coatings which can be cured by being subjected to ionizing radiation (e.g., electron beams) or actinic light (e.g., UV light).

A colored film-forming composition is then applied to the substrate to form a base coat. The base coat film-forming composition may be thermosetting or thermoplastic. Thermosetting base coat film-forming compositions suitable for use in the process of the present invention typically comprise up to 90 percent by weight, usually 10 to 90 percent by weight, based on the total weight of resin solids in the film-forming composition, of a crosslinking agent as a first component. Examples of suitable crosslinking agents include any known crosslinking agents useful in curable film-forming compositions such as aminoplasts, polycarboxylic acids and anhydrides, polyisocyanates, polyols, and polyepoxides.

Aminoplasts are obtained from the reaction of formaldehyde with an amine or amide. The most common amines or amides are melamine, urea, or benzoguanamine. However, condensates with other amines or amides can be used. While the aldehyde used is most often formaldehyde, other aldehydes such as acetaldehyde, crotonaldehyde, and benzaldehyde may be used.

The aminoplast contains methylol groups and usually at least a portion of these groups are etherified with an alcohol to modify the cure response. Any monohydric alcohol may be employed for this purpose including methanol, ethanol, and isomers of butanol and hexanol.

Most often, the aminoplasts are melamine-, urea-, or benzoguanamine-formaldehyde condensates etherified with an alcohol containing from one to four carbon atoms.

Examples of polycarboxylic acids that are suitable for use as the crosslinking agent in the base coat composition include those described in U.S. Pat. No. 4,681,811, at column 6, line 45 to column 9, line 54. Suitable polyanhydrides include those disclosed in U.S. Pat. No. 4,798,746, at column 10, lines 16-50, and in U.S. Pat. No. 4,732,790, at column 3, lines 41 to 57.

Polyisocyanate crosslinking agents may be used in the base coat composition and are typically at least partially capped. Usually the polyisocyanate crosslinking agent is a fully capped polyisocyanate with substantially no free isocyanate groups. The polyisocyanate can be an aliphatic or an aromatic polyisocyanate or a mixture of the two. Such crosslinking agents may include diisocyanates, biurets, isocyanurates, and other higher polyisocyanates.

Examples of suitable aliphatic diisocyanates are straight chain aliphatic diisocyanates such as 1,4-tetramethylene diisocyanate and 1,6-hexamethylene diisocyanate. Also, cycloaliphatic diisocyanates can be employed. Examples include isophorone diisocyanate and 4,4′-methylene-bis-(cyclohexyl isocyanate). Examples of suitable aromatic diisocyanates include 4,4′-diphenylmethane diisocyanate and toluene diisocyanate. Examples of suitable aralkyl diisocyanates are meta-xylylene diisocyanate and α,α,α′,α′-tetramethylmeta-xylylene diisocyanate

Isocyanate prepolymers, for example, reaction products of polyisocyanates with polyols such as neopentyl glycol and trimethylol propane or with polymeric polyols such as polycaprolactone diols and triols (NCO/OH equivalent ratio greater than one) can also be used.

Any suitable aliphatic, cycloaliphatic, or aromatic alkyl monoalcohol or phenolic compound may be used as a capping agent for the polyisocyanate including, for example, lower aliphatic alcohols such as methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Diethylene glycol butyl ether is preferred among the glycol ethers.

Other suitable capping agents include dimethyl pyrazole, diethyl malonate, ethylaceto acetate, oximes such as methyl ethyl ketoxime, acetone oxime and cyclohexanone oxime, lactams such as epsilon-caprolactam, and secondary amines such as dibutyl amine.

Polyols may be used as crosslinking agents for anhydride functional polymers and include those disclosed in U.S. Pat. No. 4,046,729, at column 7, line 52 to column 8, line 9; column 8, line 29 to column 9, line 66; and in U.S. Pat. No. 3,919,315, at column 2, line 64 to column 3, line 33.

Polyepoxides may be used as crosslinking agents for carboxylic acid functional polymers and include those described in U.S. Pat. No. 4,681,811, at column 5, lines 33-58.

The polymers that can be used as a second component in the base coat film-forming composition may be selected from at least one of acrylic, polyester, including alkyds, and polyurethane polymers. Note that by “polymers” is meant polymeric materials, oligomeric materials, copolymers, and homopolymers of various monomers. The polymers contain a plurality of functional groups that are reactive with the crosslinking agent, for example hydroxyl, carboxyl, carbamate, epoxy and/or amide functional groups. The polymers may be present in the base coat film-forming composition in an amount of about 10 to 100 percent by weight, typically 10 to 90 percent by weight, based on the total weight of resin solids in the film-forming composition.

Suitable functional group-containing acrylic polymers include those prepared from one or more alkyl esters of acrylic acid or methacrylic acid and, optionally, one or more other polymerizable ethylenically unsaturated monomers. Suitable alkyl esters of acrylic or methacrylic acid include methyl methacrylate, ethyl methacrylate, butyl methacrylate, ethyl acrylate, butyl acrylate and 2-ethylhexyl acrylate. Ethylenically unsaturated carboxylic acid functional monomers, for example acrylic acid and/or methacrylic acid or anhydride, can also be used when a carboxylic acid functional acrylic polymer is desired. Amide functional acrylic polymers can be formed by polymerizing ethylenically unsaturated acrylamide monomers, such as N-butoxymethyl acrylamide and N-butoxyethyl acrylamide with other polymerizable ethylenically unsaturated monomers. Non-limiting examples of suitable other polymerizable ethylenically unsaturated monomers include vinyl aromatic compounds, such as styrene and vinyl toluene; nitrites, such as acrylonitrile and methacrylonitrile; vinyl and vinylidene halides, such as vinyl chloride and vinylidene fluoride and vinyl esters, such as vinyl acetate. Examples of particularly suitable acrylic polymers that contain vinylidene fluoride are disclosed in U.S. Pat. No. 3,324,069.

Polymers containing (poly)vinylidene fluoride may alternatively be thermoplastic, in which case crosslinking agents would not be required in the base coat composition. The “curing” operation of a thermoplastic composition includes a drying and/or fusing process, typically by heating the coated substrate to a temperature and for a time sufficient to substantially remove any solvents and/or fuse the polymers present in the composition, for example, the polyvinylidene fluoride.

Electron beam curable acrylic coating compositions such as those comprising a urethane acrylate may be used as the base coat composition in the process of the present invention. Examples of such compositions include DURETHANE® products and RAYCRON® products, available from PPG Industries, Inc.

The acrylic polymers may contain hydroxyl functionality which can be incorporated into the acrylic polymer through the use of hydroxyl functional monomers such as hydroxyethyl acrylate, hydroxypropyI acrylate, hydroxybutyl acrylate, hydroxyethyl methacrylate, hydroxypropyl methacrylate, and hydroxybutyl methacrylate which may be copolymerized with the other acrylic monomers mentioned above. Caprolactone modified acrylic monomers are also suitable hydroxyl functional monomers.

The acrylic polymer can be prepared from ethylenically unsaturated, beta-hydroxy ester functional monomers. Such monomers are derived from the reaction of an ethylenically unsaturated acid functional monomer, such as monocarboxylic acids, for example, acrylic acid, and an epoxy compound that does not participate in the free radical initiated polymerization with the unsaturated acid monomer. Examples of such epoxy compounds are glycidyl ethers and esters. Suitable glycidyl ethers include glycidyl ethers of alcohols and phenols, such as butyl glycidyl ether, octyl glycidyl ether, phenyl glycidyl ether and the like. Suitable glycidyl esters include those commercially available from Shell Chemical Company under the trademark CARDURA® E; and from Exxon Chemical Company under the trademark GLYDEXX®-10.

Alternatively, the beta-hydroxy ester functional monomers are prepared from an ethylenically unsaturated, epoxy functional monomer, for example glycidyl methacrylate and allyl glycidyl ether, and a saturated carboxylic acid, such as a saturated monocarboxylic acid, for example, isostearic acid. The acrylic polymer is typically prepared by solution polymerization techniques in the presence of suitable initiators such as organic peroxides or azo compounds, for example, benzoyl peroxide or N,N-azobis(isobutyronitrile). The polymerization can be carried out in an organic solution in which the monomers are soluble by techniques conventional in the art.

Pendent and/or terminal carbamate functional groups can be incorporated into the acrylic polymer by copolymerizing the acrylic monomer with a carbamate functional vinyl monomer, such as a carbamate functional alkyl ester of methacrylic acid. These carbamate functional alkyl esters are prepared by reacting, for example, a hydroxyalkyl carbamate, such as the reaction product of ammonia and ethylene carbonate or propylene carbonate, with methacrylic anhydride. Other carbamate functional vinyl monomers can include the reaction product of hydroxyethyl methacrylate, isophorone diisocyanate and hydroxypropyl carbamate. Still other carbamate functional vinyl monomers may be used, such as the reaction product of isocyanic acid (HNCO) with a hydroxyl functional acrylic or methacrylic monomer such as hydroxyethyl acrylate, and those carbamate functional vinyl monomers described in U.S. Pat. No. 3,479,328.

Carbamate groups can also be incorporated into the acrylic polymer by a “transcarbamoylation” reaction in which a hydroxyl functional acrylic polymer is reacted with a low molecular weight carbamate derived from an alcohol or a glycol ether. The carbamate groups exchange with the hydroxyl groups yielding the carbamate functional acrylic polymer and the original alcohol or glycol ether.

The low molecular weight carbamate functional material derived from an alcohol or glycol ether is first prepared by reacting the alcohol or glycol ether with urea in the presence of a catalyst such as butyl stannoic acid. Suitable alcohols include lower molecular weight aliphatic, cycloaliphatic and aromatic alcohols, such as methanol, ethanol, propanol, butanol, cyclohexanol, 2-ethylhexanol and 3-methylbutanol. Suitable glycol ethers include ethylene glycol methyl ether and propylene glycol methyl ether. Propylene glycol methyl ether is preferred.

Also, hydroxyl functional acrylic polymers can be reacted with isocyanic acid yielding pendent carbamate groups. Note that the production of isocyanic acid is disclosed in U.S. Pat. No. 4,364,913. Likewise, hydroxyl functional acrylic polymers can be reacted with urea to give an acrylic polymer with pendent carbamate groups.

Epoxide functional acrylic polymers are typically prepared by polymerizing one or more epoxide functional ethylenically unsaturated monomers, e.g., glycidyl(meth)acrylate and allyl glycidyl ether, with one or more ethylenically unsaturated monomers that are free of epoxide functionality, e.g., methyl(meth)acrylate, isobornyl(meth)acrylate, butyl(meth)acrylate and styrene. Examples of epoxide functional ethylenically unsaturated monomers that may be used in the preparation of epoxide functional acrylic polymers include, but are not limited to, glycidyl(meth)acrylate, 3,4-epoxycyclohexylmethyl(meth)acrylate, 2-(3,4-epoxycyclohexyl)ethyl(meth)acrylate and allyl glycidyl ether. Examples of ethylenically unsaturated monomers that are free of epoxide functionality include those described above as well as those described in U.S. Pat. No. 5,407,707 at column 2, lines 17 through 56, which disclosure is incorporated herein by reference. In one embodiment of the present invention, the epoxide functional acrylic polymer is prepared from a majority of (meth)acrylate monomers.

Amide functionality may be introduced to the acrylic polymer by using suitably functional monomers in the preparation of the polymer, or by converting other functional groups to amido groups using techniques known to those skilled in the art. Likewise, other functional groups may be incorporated as desired using suitably functional monomers if available or conversion reactions as necessary.

Non-limiting examples of functional group-containing polyester polymers suitable for use as the second component in the base coat film-forming composition can include alkyds derived from drying oils and linear or branched polyesters having hydroxyl, epoxy, carboxyl anhydride, and/or carbamate functionality. Such polyester polymers are generally prepared by the polyesterification of a polycarboxylic acid or anhydride thereof with polyols and/or an epoxide using techniques known to those skilled in the art. Usually, the polycarboxylic acids and polyols are aliphatic or aromatic dibasic acids and diols. Transesterification of polycarboxylic acid esters using conventional techniques is also possible.

The polyols which usually are employed in making the polyester (or the polyurethane polymer, as described below) include alkylene glycols, such as ethylene glycol and other diols, such as neopentyl glycol, hydrogenated Bisphenol A, cyclohexanediol, 1,6-hexanediol, 2-methylpropanediol, butyl ethyl propane diol, trimethyl pentane diol, cyclohexanedimethanol, caprolactonediol, for example, the reaction product of epsilon-caprolactone and ethylene glycol, hydroxy-alkylated bisphenols, polyether glycols, for example, poly(oxytetramethylene) glycol and the like. Polyols of higher functionality may also be used. Examples include trimethylolpropane, trimethylolethane, pentaerythritol, tris-hydroxyethylisocyanurate and the like.

The acid component used to prepare the polyester polymer can include, primarily, monomeric carboxylic acids or anhydrides thereof having 2 to 18 carbon atoms per molecule. Among the acids which are useful are cycloaliphatic acids and anhydrides, such as phthalic acid, isophthalic acid, terephthalic acid, tetrahydrophthalic acid, hexahydrophthalic acid, methylhexahydrophthalic acid, 1,3-cyclohexane dicarboxylic acid and 1,4-cyclohexane dicarboxylic acid. Other suitable acids include adipic acid, azelaic acid, sebacic acid, maleic acid, glutaric acid, decanoic diacid, dodecanoic diacid and other dicarboxylic acids of various types. The polyester may include minor amounts of monobasic acids such as benzoic acid, stearic acid, acetic acid and oleic acid. Also, there may be employed higher carboxylic acids, such as trimellitic acid and tricarballylic acid. Where acids are referred to above, it is understood that anhydrides thereof which exist may be used in place of the acid. Also, lower alkyl esters of diacids such as dimethyl glutarate and dimethyl terephthalate can be used.

Pendent and/or terminal carbamate functional groups may be incorporated into the polyester by first forming a hydroxyalkyl carbamate which can be reacted with the polyacids and polyols used in forming the polyester. The hydroxyalkyl carbamate is condensed with acid functionality on the polyester yielding carbamate functionality. Carbamate functional groups may also be incorporated into the polyester by reacting a hydroxyl functional polyester with a low molecular weight carbamate functional material via a transcarbamoylation process similar to the one described above in connection with the incorporation of carbamate groups into the acrylic polymers or by reacting isocyanic acid with a hydroxyl functional polyester.

Epoxide functional polyesters can be prepared by art-recognized methods, which typically include first preparing a hydroxy functional polyester that is then reacted with epichlorohydrin. Polyesters having hydroxy functionality may be prepared by art-recognized methods, which include reacting carboxylic acids (and/or esters thereof having acid (or ester) functionalities of at least 2, and polyols having hydroxy functionalities of at least 2. As is known to those of ordinary skill in the art, the molar equivalent ratio of carboxylic acid groups to hydroxy groups of the reactants is selected such that the resulting polyester has hydroxy functionality and the desired molecular weight.

Amide functionality may be introduced to the polyester polymer by using suitably functional reactants in the preparation of the polymer, or by converting other functional groups to amido-groups using techniques known to those skilled in the art. Likewise, other functional groups may be incorporated as desired using suitably functional reactants if available or conversion reactions as necessary.

Non-limiting examples of suitable polyurethane polymers having :pendent and/or terminal functional groups include the polymeric reaction products of polyols, which are prepared by reacting the polyester polyols or acrylic polyols, such as those mentioned above, or polyether polyols, such as those mentioned below, with a polyisocyanate such that the OH/NCO equivalent ratio is greater than 1:1 such that free hydroxyl groups are present in the product. Alternatively, isocyanate functional polyurethanes may be prepared using similar reactants in relative amounts such that the OH/NCO equivalent ratio is less than 1:1. Such reactions employ typical conditions for urethane formation, for example, temperatures of 60° C. to 90° C. and up to ambient pressure, as known to those skilled in the art.

The organic polyisocyanates that can be used to prepare the functional group-containing polyurethane polymer include one or more aliphatic or aromatic diisocyanates or higher polyisocyanates.

Examples of suitable:aromatic diisocyanates include 4,4′-diphenylmethane diisocyanate, meta-xylylene diisocyanate and toluene diisocyanate. Examples of suitable aliphatic diisocyanates include α,α,α′,α′-tetramethylmeta-xylylene diisocyanate and straight chain aliphatic diisocyanates, such as 1,6-hexamethylene diisocyanate. Also, cycloaliphatic diisocyanates can be employed. Examples include isophorone diisocyanate and 4,4′-methylene-bis-(cyclohexyl isocyanate). Examples of suitable higher polyisocyanates include 1,2,4-benzene triisocyanate and polymethylene polyphenyl isocyanate.

Terminal and/or pendent carbamate functional groups can be incorporated into the polyurethane by reacting a polyisocyanate with a polyester polyol containing the terminal/pendent carbamate groups. Alternatively, carbamate functional groups can be incorporated into the polyurethane by reacting a polyisocyanate with a polyester polyol and a hydroxyalkyl carbamate or isocyanic acid as separate reactants. Carbamate functional groups can also be incorporated into the polyurethane by reacting a hydroxyl functional polyurethane with a low molecular weight carbamate functional material via a transcarbamoylation process similar to the one described above in connection with the incorporation of carbamate groups into the acrylic polymer. Additionally, an isocyanate functional polyurethane can be reacted with a hydroxyalkyl carbamate to yield a carbamate functional polyurethane.

Amide functionality may be introduced to the polyurethane polymer by using suitably functional reactants in the preparation of the polymer, or by converting other functional groups to amido-groups using techniques known to those skilled in the art. Likewise, other functional groups may be incorporated as desired using suitably functional reactants if available or conversion reactions as necessary.

The base coat compositions may be any solventborne or waterborne composition known in the art. Waterborne base coats in color-plus-clear compositions are disclosed in U.S. Pat. No. 4,403,003, and the resinous compositions used in preparing these base coats can be used in the practice of this invention. Also, waterborne polyurethanes such as those prepared in accordance with U.S. Pat. No. 4,147,679 can be used as the resinous lo binder in the base coat. Further, waterborne coatings such as those described in U.S. Pat. No. 5,071,904 can be used as the base coat. However, solventborne base coat compositions are preferred, particularly when the process of the present invention is performed as a coil coating process.

The base coat contains pigments typically to provide color. Compositions containing metallic flake pigmentation are useful for the production of so-called “glamour metallic” finishes chiefly upon the surface of automobile bodies. Suitable metallic pigments include, in particular, aluminum flake, copper flake, bronze flake, nickel flake, tin flake, silver flake, and micaceous pigments, for example, metal oxide coated mica.

Besides the metallic pigments, the base coating compositions may contain non-metallic color pigments conventionally used in surface coatings including inorganic pigments such as titanium dioxide, iron oxide, chromium oxide, mixed metal oxides, lead chromate, and carbon black, and organic pigments such as phthalocyanine blue and phthalocyanine green. In general, the total pigment is incorporated into the coating composition in amounts of about 1 to 80 percent by weight based on weight of coating solids. The metallic pigment may be employed in amounts up to 25 percent by weight based on the total weight of coating solids.

If desired, the base coat composition may contain additional materials well known in the art of formulated surface coatings. These would include surfactants, flow control agents, thixotropic agents, fillers, anti-gassing agents, organic cosolvents, catalysts, UV light absorbers, hindered amine light stabilizers, and other customary auxiliaries. These materials can constitute up to 80 percent by weight of the total weight of the coating composition.

The base coat composition may most often be applied to the substrate by roll coat. Roll coating may be direct or reverse roll coating, as disclosed in the article “Coil Coatings”, cited above.

During application of the base coat composition to the substrate, a film of the base coat is formed on the substrate and the base coat is cured as described below. Typically, the cured base coat film thickness will be about 0.01 to 5 mils (0.254 to 127 microns), typically 0.1 to 2 mils (2.54 to 50.8 microns) in thickness.

As mentioned above, after the base coat composition is applied to the substrate it is then cured by heating the substrate to a temperature and for a time sufficient to effect cure, or the substrate is exposed to a suitable radiation source, depending on the chemistry of the coating composition. In a heat cure process, oven dwell time is typically 15 to 120 seconds with a peak metal temperature as high as 390 to 500° F. (199 to 260° C.).

If the base coat composition is radiation curable, it may be at least partially cured by exposure to ionizing radiation. Under such circumstances, the coating is typically exposed to ionizing radiation in an amount in the range of from about 0.01 megarad to about 30 megarads, although doses greater than 20 megarads may be used satisfactorily. The dose, however, should not be so great that the chemical or physical properties of the coating are seriously impaired. Typically, the dose is in the range of from about 0.1 megarad to about 20 megarads.

Alternatively, a radiation curable base coat may be at least partially cured by exposure to actinic light. Under such circumstances, a photoinitiator, photosensitizer or mixtures of photoinitiator and photosensitizer are typically present in the coating formulation to absorb photons and produce the free radicals necessary for crosslinking.

After curing the base coat, at least one clear film-forming composition is applied over at least a portion of the base coat to form at least one transparent topcoat over the base coat. The clear film-forming composition may be thermosetting or thermoplastic. Thermosetting clear film-forming compositions suitable for use in the process of the present invention typically comprise up to 90 percent by weight, usually 10 to 90 percent by weight, based on the total weight of resin solids in the film-forming composition, of a crosslinking agent as a first component. Examples of suitable crosslinking agents include any known crosslinking agents useful in curable film-forming compositions such as aminoplasts, polycarboxylic acids and anhydrides, polyisocyanates, polyols, and polyepoxides, including all those discussed above. The clear film-forming compositions also may comprise 10 to 100 percent by weight, typically 10 to 90 percent by weight, based on the total weight of resin solids in the film-forming composition, of a polymer as a second component, having functional groups that are reactive with the respective crosslinking agent. Suitable polymers include those disclosed above with respect to the base coat composition, as well as vinyl fluoropolymers. A particularly suitable hydroxyl functional, vinyl fluoropolymer suitable for use in a clear coat composition is disclosed in U.S. Pat. No. 4,345,057, and is available from Asahi Glass Company, Ltd., as LUMIFLON® 552.

At least one of the clear film-forming compositions contains an effect pigment. By “effect pigment” is meant a pigment that produces a visual effect such as metallic brightness, pearlescence, or opalescence. Effect pigments cause the appearance (such as color or brightness) of the coated substrate to change when the coated substrate is viewed from different angles. Not intending to be bound by any theory, it is believed that the inclusion of effect pigments in at least one of the clear coats produces a desired pigment flake orientation therein and counteracts the effects of compressed pigment orientation in base coats that are roll applied, particularly during coil coating processes.

Examples of suitable effect pigments include in particular aluminum flake, copper flake, bronze flake, nickel flake, tin flake, silver flake, and micaceous pigments, for example, metal oxide coated mica. The effect pigment is present in at least one clear film-forming composition in an amount at least sufficient to produce the desired visual effect, up to 25 percent by weight, typically up to 15 percent by weight, often up to 5 percent by weight, based on the total weight of resin solids in the film-forming composition, depending on the particular pigment used and the desired color.

If desired, the clear coat composition may contain additional materials well known in the art of formulated surface coatings. Examples of such additional materials include, but are not limited to, surfactants, flow control agents; thixotropic agents, anti-gassing agents, organic cosolvents, catalysts, UV light absorbers, hindered amine light stabilizers, anti-oxidants, adjuvant resins, inorganic microparticles, for example, silica in colloidal, fumed, or amorphous form, alumina or colloidal alumina, titanium dioxide, cesium oxide, yttrium oxide, colloidal yttrium, zirconia, for example, colloidal or amorphous zirconia, and other customary auxiliaries. These materials can constitute up to 80 percent by weight of the total weight of the coating composition.

The clear coat composition may be applied to the substrate by any conventional method such as immersion, brushing, spray application or roll coat (direct or reverse).

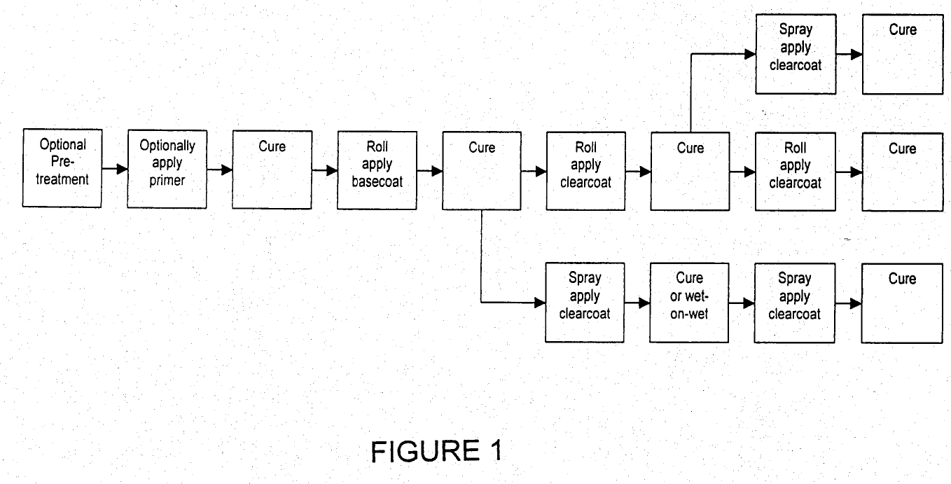

In several alternative embodiments of the process of the present invention, the clear coat(s) may be applied to the substrate by a variety of methods as shown in FIG. 1. For example, in one embodiment of the present invention, a first clear film-forming composition and a second clear film-forming composition may both be applied by roll coating. This is particularly suitable when the coating process is a continuous coil coating process. In this embodiment, the first clear coat is typically cured prior to the application and curing of the second clear coat. Curing may be conducted as described above with respect to the base coat. In another embodiment, a first clear coat may be applied by roll coating and then cured, and a second clear coat may be applied by spray application, either as part of a continuous coating process or after removal of the substrate from the coil line. Removal from the continuous process line allows for shaping or forming of the metal part prior to clear coat application, if desired. In yet another embodiment, a first clear film-forming composition and a second clear film-forming composition may both be applied by spray coating. In this embodiment, either one or both of the clear coats may be applied as part of a continuous coating process or after removal of the substrate from the process line. Alternatively, both clear coats may be applied after removal of the substrate from the process line. In this alternative embodiment, the clear coats may be applied “wet-on-wet”; i. e., using the process of applying one layer of a coating before the previous layer is cured, then simultaneously curing both layers. Spray application of one or more clear coats after removal of the substrate from the process line allows for the use of clear coat compositions that are not necessarily suitable or convenient for use on a coil coating line, for example two-package systems such as acid-epoxy or isocyanate cured compositions, powder compositions, and relatively non-flexible clear coats that may be applied after post-forming operations.

It should be understood, that for purposes of the present invention, when more than one clear coating is applied to the base coat, the clear coating compositions can be the same or different compositions.

The process of the present invention is particularly suited to continuous coil coating process lines. However, the process may be used in other continuous manufacturing methods, such as the coating of pre-cut sheets of metal or plastic plates called “blanks”, which after coating may be cut into shapes and fabricated into molded industrial or automotive parts. The term “blank” refers to a flat or substantially flat section cut or “sheared” from a coiled metal strip and subsequently formed into a part, such as automotive parts, front and side panels for appliances, e.g., refrigerators, washers and dryers, metal office furniture, e.g., filing cabinets and desks, and building products, e.g., fluorescent lighting fixtures. Often holes must be punched in the blanks.

As used herein, the term “cure” as used in connection with a composition, e.g., “a curable composition,” “a thermosetting composition”, or “a thermoplastic composition” shall mean that any crosslinkable components of the composition are at least partially crosslinked. In thermoplastic compositions, “cure” typically refers to a drying and/or fusing process, typically by heating the coated substrate to a temperature and for a time sufficient to substantially remove any solvents and/or fuse the polymer.

In certain embodiments of the present invention, the crosslink density of the crosslinkable components, i.e., the-degree of crosslinking, ranges from 5% to 100% of complete crosslinking. In other embodiments, the crosslink density ranges from 35% to 85% of full crosslinking. In other embodiments, the crosslink density ranges from 50% to 85% of full crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen. This method determines the glass transition temperature and crosslink density of free films of coatings or polymers. These physical properties of a cured material are related to the structure of the crosslinked network.

According to this method, the length, width, and thickness of a sample to be analyzed are first measured, the sample is tightly mounted to the Polymer Laboratories MK III apparatus, and the dimensional measurements are entered into the apparatus. A thermal scan is run at a heating rate of 3° C./min, a frequency of 1 Hz, a strain of 120%, and a static force of 0.01N, and sample measurements occur every two seconds. The mode of deformation, glass transition temperature, and crosslink density of the sample can be determined according to this method. Higher crosslink density values indicate a higher degree of crosslinking in the coating.

Substrates coated by the process of the present invention demonstrate excellent appearance properties and are suitable for use in the manufacture of automotive parts. Outstanding appearance properties include brightness of face, color, and other decorative visual effects due to the presence of effect pigments in the clear coat(s). Color matching of substrates coated by the process of the present invention with conventionally spray coated substrates is improved, compared to color-plus-clear composite coatings comprising roll coated base coats and pigment-free clear coats.

The invention will be further described by reference to the following examples. Unless otherwise indicated, all parts are by weight.

### EXAMPLE 1 AND COMPARATIVE EXAMPLE 2

Examples 1 and 2 describe the preparation of a clear coat composition containing effect pigments (suitable for application over a basecoat in the processes of the present invention) and an analogous clear coat containing no effect pigments, respectively. The clear coat compositions were prepared by mixing under mild agitation the following ingredients.

| | Example 1 | Example 2** |
|---|---|---|
| | Parts by Weight | Parts by Weight |
| Ingredients | solution | solution |
| Dipropylene glycol monomethyl | 17.50 | 17.50 |
| ether | | |
| Estasol DBE¹ | 10.5 | — |
| Diacetone alcohol | 10.5 | — |
| TINUVIN 400² | 2.94 | 2.94 |
| TINUVIN 123³ | 1.00 | 1.00 |
| LUMIFLON 552⁴ | 179.25 | 179.25 |
| DESMODUR VPLS2078⁵ | 25.00 | 25.00 |
| DESMODUR XP-7018E⁶ | 17.73 | 17.73 |
| Polybutyl acrylate | 0.50 | 0.50 |
| BYK 306⁷ | 0.42 | 0.42 |
| Dibutyltin dilaurate | 0.50 | 0.50 |
| ALPASTE 5660NS⁸ | 0.01 | — |
| AFFLAIR 9602⁹ | 0.055 | — |
| 639Z MEARLIN Super Blue¹⁰ | 0.027 | — |

**Comparative
¹Dibasic ester available from Chemoxy.
²Ultraviolet light absorber available from Ciba Specialty Chemicals.
³Ultraviolet light absorber available from Ciba Specialty Chemicals
⁴Fluorinated vinyl copolymer available from Asahi Glass.
⁵Polyisocyanate crosslinking agent available from Bayer Corp.
⁶Polyisocyanate crosslinking agent available from Bayer Corp.
⁷Flow control additive available from BYK-Chemie.
⁸Aluminum pigment paste available from Toyal America, Inc.
⁹Silvergray mica pigment available from EM Industries, Inc.
¹⁰Blue mica pigment available from Englehard Corporation.

### EXAMPLE3

This example describes the preparation of a metallic basecoat useful in the methods of the present invention. The basecoat was prepared by admixing under mild agitation the following ingredients.

| | Parts by Weight |
|---|---|
| Ingredients | (solution) |
| Ethyl 3-ethoxypropionate | 4.00 |
| Dipropylene glycol monomethyl ether | 6.00 |
| Estasol DBE | 20.00 |
| CYMEL 303¹ | 15.00 |
| Polyester resin² | 105.00 |
| NACURE 1419³ | 1.70 |
| DYNOADD F-1⁴ | 0.50 |
| VERSAFLOW base⁵ | 0.10 |
| ALPASTE 5660NS | 0.35 |
| 639Z MEARLIN Super Blue | 1.50 |
| White tint paste⁶ | 2.00 |
| Black tint paste⁷ | 35.60 |
| Blue tint paste⁸ | 8.45 |
| ¹Melamine crosslinking agent available from Cytec Industries, Inc. | |
| ²Condensation reaction product of ethylene glycol 10.8%; 1,6-hexanediol 7.0%; neopentyl glycol 16.1%; trimethylol propane 4.0%; and hexahydrophthalic anhydride 62.12% (65% solids in a solvent blend of Aromatic 100 and methyl ether propylene glycol acetate in a 75/25 mixing ratio). | |
| ³Covalently blocked dinonylnaphthalene sulfonic acid catalyst available from King Industries, Inc. | |
| ⁴Flow add available from Dyno Cytec. | |
| ⁵Flow add available from Shamrock Technologies. | |
| ⁶Pigment grind paste comprising 33.6% polyester resin (neopentyl glycol 41.2%/trimethylol propane 5.3%/isophthalic acid 16.9%/terephthalic acid 10.9%/phthalic anhydride 8.3%/adipic acid 17.4%, 60% solids in a 61/39 ratio blend of n-butyl acetate and xylene); 14.2% FM-003 V60, a melamine resin available from Cytec Industries, Inc.; 5.1% n-butyl acetate; 1.9% MPA2000X, rheology modifier available from Elementis Specialties; 5.2% DISPERBYK-180, a dispersant available from BYK-Chemie; 40.0% TITANE | |
| # from Kemira. | |

⁷Pigment grind paste comprising 36.2% polyester resin of footnote 6; 15.5% FM-003 V60 melamine resin; 28.1% n-butyl acetate; 4.0% n-butyl alcohol; 7.2% DISPERBYK-163, a dispersant available from BYK-Chemie; and 9.0% FW-200, a black pigment available from Degussa Pigments.
⁸Pigment grind paste comprising 39.2% of polyester resin of footnote 6; 16.8% FM-003 V60 melamine resin; 28.0% n-butyl acetate; and 16.0% IRGAZIN blue AFR pigment available from Ciba Specialty Chemicals.

Test Panel Preparation:

Three sets of test panels were prepared to illustrate the process of the present invention as compared spray application techniques conventionally used in the OEM automotive industry. Each of two sets of test panels illustrating the process of the present invention were prepared by both draw down application techniques (“DD”) roll coating application techniques (“RC”). One set represents the process of the present invention where a color-plus-clear composite system was prepared using a clear coating composition containing effect pigments (Example 1). A second and comparative set was prepared using the same application techniques but forming the color-plus-clear composite coating using a clear coating composition containing no effect pigments (Example 2). A third and comparative set of test panels was prepared as described below using conventional spray application techniques to apply commercially available base coat and clear coat compositions.

Draw Down Application

Pretreated aluminum test panels (6″×12″×0.018″), available from Commonwealth Aluminum, which had been pretreated with PERMATREAT™ 1500 available from GE Betz, were coated with primer coating 1PMB5721, available from PPG Industries, Inc. The primer coating was applied to the pretreated test panels using a wire wound draw down bar (#36), and cured in a conveyor oven using a 30-second dwell time to achieve a peak metal temperature (“PMT”) of 4650 (241° C.). The cured primer coating had a dry film thickness of 0.7 to 0.8 mils (17.5 to 20 micrometers).

The basecoat composition of Example 3 above, then was applied to the primer-coated test panels using a wire wound draw dow n bar (#46), and cured in a conveyor oven using a 30-second dwell time to achieve a PMT of 450° F. (232° C.). The resulting cured basecoat had a dry film thickness of 0.7 to 0.8 mills (17.5 to 20 micrometers).

Two separate sets of test panels were prepared Wherein each of the clear coating compositions of Examples 1 and 2 above were then applied to the cured base coat in two successive applications as follows. First, the clear coating composition was applied to the cured basecoat layer using a wire Wound draw down bar (#48), and heated in a conveyor oven with a dwell time of 30 seconds to achieve a PMT of 450° F. (232° C.). The n a second clear coat layer was applied to the first clear coat layer by applying the clear coating composition of Example 1 above to the first clear coat layer using a wire wound draw down bar (#48) and cured in a conveyor oven with a dwell time of 30 seconds to achieve a PMT of 465° F. (241° C.). Each of the clear coat layers had a dry film thickness of 0.7 to 0.8 mils (17.5 to 20 micrometers).

Roll Coat Application:

Pretreated aluminum test panels (6″×12″×0.018″), available from Commonwealth Aluminum, which had been pretreated with PERMATREAT 1500 available from GE Betz, were coated with primer coating 1PMB5721, available from PPG Industries, Inc. The primer coating was applied to the pretreated test panels using a wire wound draw down bar (#36), and cured in a conveyor oven using a 30-second dwell time to achieve a peak metal temperature (“PMT”) of 465° (241° C). The cured primer coating had a dry film thickness of 0.7 to 0.8 mils (17.5 to 20 micrometers).

Using a lab roll coater (belt 200 feet per minute (“fpm”); applicator roll at 250 fpm; pick-up roll at 125 fpm), the basecoat composition of Example 3 above was applied to the primer-coated test panels. The basecoated test panels were cured for 35 seconds in a high velocity box oven to achieve a PMT of 450° F. (232° C.). The resulting basecoat had a dry film thickness of 0.6 to 0.7 mils (15 to 17.5 micrometers).

Two separate sets of test panels were prepared by roll coat application of the clear coating composition of Example 1 to one set of basecoated panels and the clear coating composition of Example 2 to a second set. The clear coats were applied as follows. Using a lab roll coater (belt at 200 fpm; applicator roll at 250 fpm; and pick-up roll at 125 fpm), each of the clear coating compositions of Examples 1 and 2 were applied I two successive coats to the basecoated test panels. After roll application of the first clear coat layer, the coated panels were cured for 30 seconds in a high velocity box oven to achieve a PMT of 420° F. (216° C.). Each of the first clear coat layers had a dry film thickness of 0.7 to 0.8 mils (17.5 to 20 micrometers). Subsequently, a second clear coat layer was applied using the same roll coater and parameters, and the coated panels were cured for 30 seconds in a high velocity box oven to achieve a PMT of 465° F. (241° C.). The second clear coat had a dry film thickness of 0.7 to 0.8 mils (17.5 to 20 micrometers).

Spray Application:

To simulate a conventionally spray-applied automotive OEM coating system for comparative purposes, test panels were prepared as follows. Pre-primed panels available from ACT Laboratories (cold rolled steel (4″×12″×0.032″), pretreated with C710 C18 DI water rinse, available from PPG Industries, Inc., followed by electrocoating with ED5000 available from PPG Industries, Inc.; and primed with 1177225A gray available from PPG Industries, Inc.) were coated in two passes with 96911 HydroBasecoat Ebonyschwarz, black basecoat available from PPG Industries, Inc. using spraymation application (70° F. at 60% relative humidity). Coated panels were given a dehydration period of five minutes at ambient conditions, then dried/cured at a temperature of 176° F. (80° C.) for a period of 5 minutes. The resulting base coat had a dry film thickness of 0.5 to 0.6 mils (12.5 to 15 micrometers).

A two component polyurethane clearcoating composition, 74770 available from BASF Corporation was then applied to the base coat in two passes using spraymation application, with a 45-second flash period between passes. The clear coated panels were give a flash period of 7 minutes at ambient conditions, then the coated panels were cured at a temperature of 285° F. (141° C.) for 15 minutes. The resulting clear coat had a dry film thickness of 1.5 to 1.6 mils (38 to 40 micrometers).

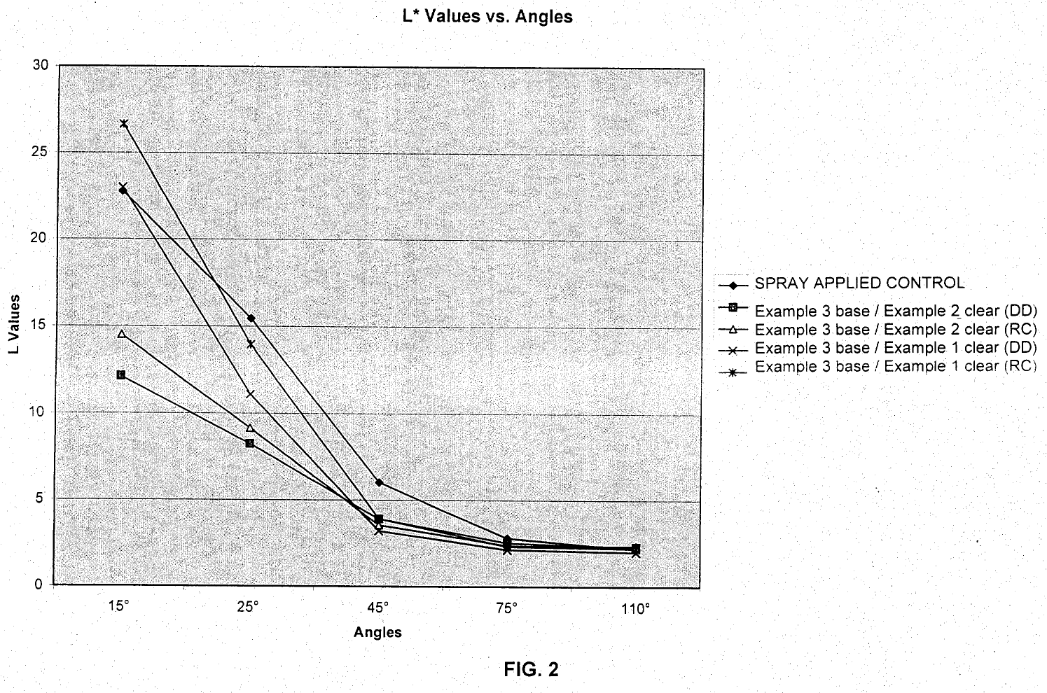

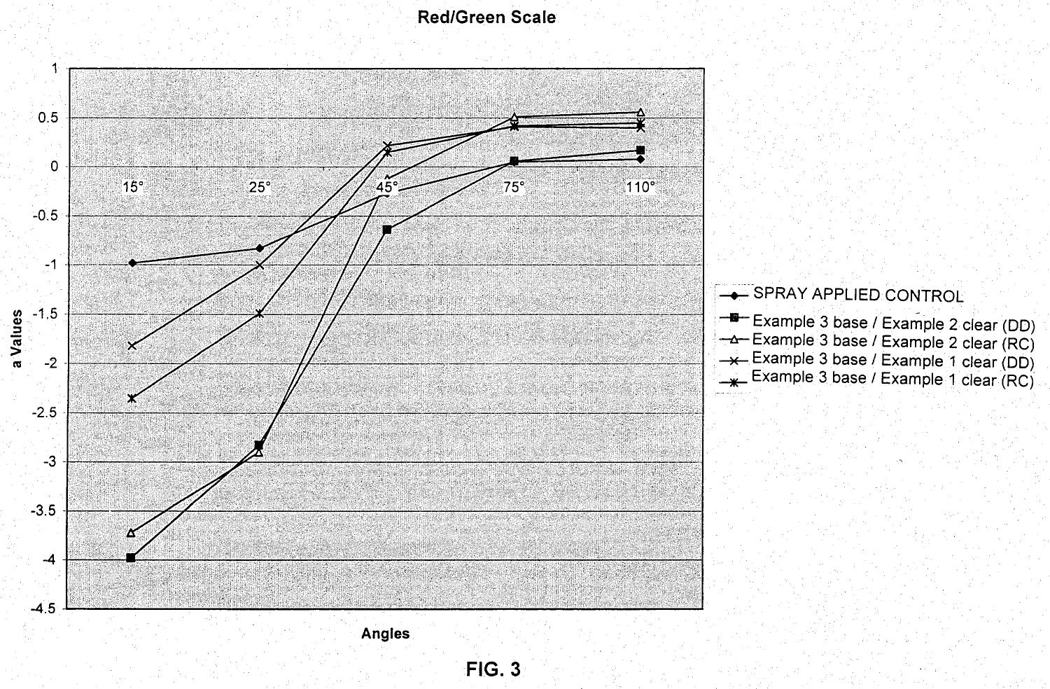

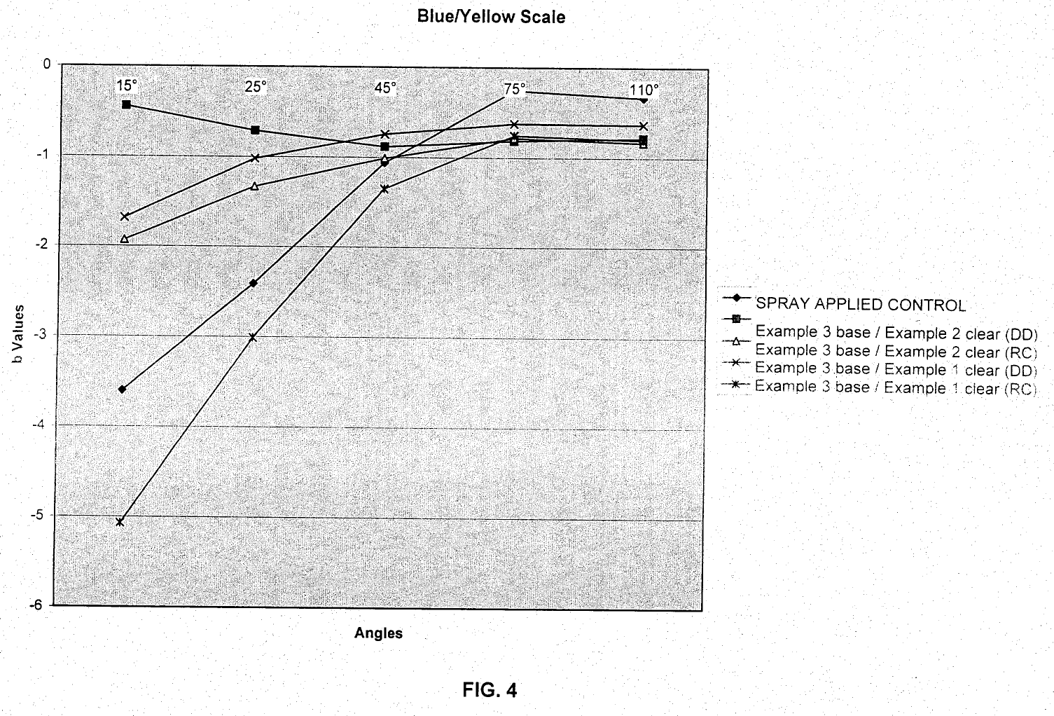

The test panels prepared as described above were evaluated for color at various angles using X-Rite MA 68II Multi-Angle Spectrophotometer available from X-Rite, Inc. FIG. 2, illustrates that the “L* values” over a range of viewing angles, for the coating systems prepared by the method of the present invention, whether applied via draw down or roll coating techniques, approach the lightness/darkness values of a conventionally spray applied. FIG. 3 illustrates that the “a values”, i.e., the color on the red/green scale, over a range of viewing angles, for the coating systems of the present invention where the clear coating comprises effect pigments, whether applied via draw down or roll coating techniques, approaches the a values over a range of viewing angles for the coating system applied by conventional spray techniques. Likewise, FIG. 4 illustrates that the “b values”, i.e., the color on the blue/yellow scale, over a range of viewing angles, for the coating systems of the present invention where the clear coating comprises effect pigments, applied via roll coating techniques approaches the b values for the coating system applied by conventional spray techniques.

We claim:

1. A process for applying a multi-component composite coating composition to a substrate which comprises roll applying to the substrate a colored film-forming composition to form a base coat and applying to at least a portion of said base coat at least one clear film-forming composition to form at least one transparent top coat over the base coat wherein at least one of the clear film-forming compositions contains an effect pigment.

2. The process of claim 1 wherein the substrate is a metal substrate.

3. The process of claim 1 wherein said process is continuous.

4. The process of claim 3 wherein said process is a coil coating process.

5. The process of claim 1 wherein the effect pigment is present in at least one of the clear film-forming compositions in an amount at least sufficient to produce a desired visual effect, up to 25 percent by weight based on the total weight of resin solids in the clear film-forming composition.

6. The process of claim 5 wherein a first clear film-forming composition and a second clear film-forming composition are both applied by roll coating.

7. The process of claim 5 wherein a first clear film-forming composition is applied by roll coating and a second clear film-forming composition is spray applied.

8. The process of claim 5 wherein a first clear film-forming composition and a second clear film-forming composition are both spray applied.

9. The process of claim 8 wherein the second clear film-forming composition is applied to the first clear film-forming composition wet-on-wet, and then both clear film-forming compositions are subsequently simultaneously cured.

10. A process for applying a multi-component composite coating composition to a metal substrate comprising the following steps:
a) optionally contacting the substrate surface with a pretreatment composition; followed by
b) optionally applying a primer coating composition to the substrate surface;
c) curing the primer coating composition if applied;
d) roll applying to the substrate a colored film-forming composition to form a base coat;
e) curing the base coat;
f) applying to at least a portion of said base coat at least one clear film-forming composition to form at least one transparent top coat over the base coat wherein at least one of the clear film-forming compositions contains an effect pigment; and
g) curing the at least one clear coat.

11. The process of claim 10 wherein a first clear film-forming composition and a second clear film-forming composition are both applied by roll coating in step f), and the first clear film-forming composition is cured prior to the application and curing of the second clear film-forming composition.

12. The process of claim 10 wherein a first clear film-forming composition is applied by roll coating and a second clear film-forming composition is spray applied in step f), wherein the first clear film-forming composition is cured prior to the application and curing of the second clear film-forming composition.

13. The process of claim 10 wherein a first clear film-forming composition and a second clear film-forming composition are both spray applied.

14. The process of claim 13 wherein the second clear film-forming composition is applied to the first clear film-forming composition wet-on-wet, and then both clear film-forming compositions are subsequent simultaneously cured.

15. The process of claim 10 further comprising the step of cleaning the metal surface with an alkaline cleaner before step a).

16. The process of claim 15 further comprising the step of rinsing the metal surface with an aqueous acidic solution after cleaning with the alkaline cleaner and before step a).

17. The process of claim 10 wherein said process is continuous.

18. The process of claim 17 wherein said process is a coil coating process.

19. The process of claim 10 wherein the effect pigment is present in at least one of the clear film-forming compositions in an amount at least sufficient to produce a desired visual effect, up to 25 percent by weight based on the total weight of resin solids in the clear film-forming composition.

20. The process of claim 10 wherein the metal substrate is aluminum.

21. The process of claim 10 wherein the metal substrate is steel or surface-treated steel.

22. The process of claim 10 wherein the steel substrate is coated with an alloy of zinc, or aluminum and zinc.

23. A substrate coated in accordance with the process of claim 1.

24. A substrate coated in accordance with the process of claim 10.
